(19) United States
(12) Patent Application Publication
(10) Pub. No.: US 2024/0198851 A1
(43) Pub. Date: Jun. 20, 2024

(54) ELECTRIC VEHICLE WITH REMOTE ACTIVATION

(71) Applicant: Taiga Motors Inc., Lasalle (CA)

(72) Inventors: Cyrus LARSEN, Vancouver (CA); David-Emmanuel GADOURY, Montreal (CA); Rodrigo ARRAMBIDE, Montreal (CA); Mackenzie MURRAY, Montreal (CA); Jean-Philippe LANDRY, Terrebonne (CA); Gabriel BERNATCHEZ, Montreal (CA)

(73) Assignee: Taiga Motors Inc., Lasalle (CA)

(21) Appl. No.: 18/524,251

(22) Filed: Nov. 30, 2023

Related U.S. Application Data
(60) Provisional application No. 63/433,595, filed on Dec. 19, 2022.

(51) Int. Cl. B60L 58/12; B60L 53/22; B60L 58/18; B62J 45/20

(52) U.S. Cl. CPC B60L 58/12; B60L 53/22; B60L 58/18; B62J 45/20; B60L 2210/10

(57) ABSTRACT

An electric vehicle including a vehicle controller to control operation of the electric vehicle when the electric vehicle is in an on state and enter a powered-off state when the electric vehicle is in an off state, and an activation controller to store a programmable wake time. The activation controller to switch the vehicle controller to a powered-on state from the powered-off state to wake the electric vehicle from the off state to the on state at the wake time.

### CROSS-REFERENCE TO RELATED APPLICATIONS

This application claims priority from U.S. Provisional Patent Application No. 63/433,595, filed Dec. 19, 2022, which is incorporated by reference in its entirety herein.

### TECHNICAL FIELD

The present disclosure relates generally to electric vehicles, including electric powersports vehicles, and, more particularly, to examples of an electrical control system and associated operating methods for an electric vehicle.

### BACKGROUND

Electric vehicles (EVs), including electric powersport vehicles (EPVs), such as snowmobiles, personal watercraft, and side-by-sides, for example, employ rechargeable batteries to store energy to power the vehicle. When not in use, EVs are typically placed in an inactive or standby state, where only limited vehicle functionality is enabled (e.g., door lock operation), in order to minimize power draw from the batteries. During extended periods of vehicle inactivity, which may be common for EPVs, the amount of energy required to provide even limited vehicle functionality may deplete the batteries.

### SUMMARY

One example provides an electric vehicle including a vehicle controller to control operation of the electric vehicle when the electric vehicle is in an on state and enter a powered-off state when the electric vehicle is in an off-state, and an activation controller to store a programmable wake time. The activation controller to turn the vehicle controller to a powered-on state from the powered-off state to wake the electric vehicle from the off state to the on state at the wake time.

In some embodiments, the wake time is programmable by the vehicle controller.

In some embodiments, the vehicle controller is a main body controller.

In some embodiments, the activation controller is the only controller of the electric vehicle which is powered-on when the electric vehicle is in the off state.

In some embodiments, the wake time is based on a user designated time.

In some embodiments, the user designated time is specified in a user entry of a local task schedule stored by the activation controller and/or the vehicle controller.

In some embodiments, where the user entry of the local task schedule includes the user designated time and has a corresponding designated vehicle operation, upon being turned to the powered-on state from the power-off state by activation controller at the wake time, the vehicle controller to perform the corresponding vehicle operation designated by the user entry.

In some embodiments, wherein the designated vehicle operation comprises a battery preconditioning operation of a high-voltage battery of the electric vehicle.

In some embodiments, the vehicle controller performs the battery preconditioning operation only if the electric vehicle is powered from external power equipment.

In some embodiments, the designated vehicle operation comprises a status report of one or more operating parameters of the electric vehicle, including operating parameters of a high-voltage battery of the electric vehicle.

In some embodiments, the wake time is based on a wake interval.

In some embodiments, when the electric vehicle is in the off state, upon expiration of the wake interval, the activation controller to turn the vehicle controller to the powered-on state from the powered-off state to wake the electric vehicle from the off state to the on state, and to initiate the vehicle controller to perform a check for remote user communication with the electric snowmobile which was made when the electric vehicle was in the off state.

In some embodiments, to perform the check for remote user communication, the vehicle controller to download remotely entered user designated times from a memory remote to the electric vehicle to the memory of the activation controller.

In some embodiments, the wake interval is fixed over time.

In some embodiments, the wake interval varies over time based on user interactions with the electric vehicle.

In some embodiments, the electric vehicle further comprises a high-voltage (HV) battery; and a low-voltage (LV) battery, wherein: the activation controller is powered from the LV battery; and the vehicle controller is powered from the HV battery via a direct current to direct current (DC/DC) converter when the electric vehicle is in the on state, and electrically disconnected from the HV battery when the vehicle is in the off state.

In some embodiments, the activation controller is continuously powered from the LV battery.

In some embodiments, the LV battery is charged from the HV battery via the DC/DC converter when the electric vehicle is in the on state.

In some embodiments, the wake time is based on a battery charging interval.

In some embodiments, when the electric vehicle is in the off state, upon expiration of a battery charging interval, the activation controller to turn the vehicle controller to a powered-on state from a powered-off state to wake the electric vehicle from an off state to an on state, and to initiate the vehicle controller to perform a charging operation of the LV battery from the HV battery.

In some embodiments, the battery charging interval is reset each time the electric vehicle transitions from the on state to the off state.

One example provides a method of operating an electric vehicle having an off state and an on-state, the method including storing a programmable wake time in an activation controller of the electric vehicle, switching a vehicle controller of the electric vehicle to a powered-off state to switch the electric vehicle to the off state, and waking the electric vehicle from the off-state to the on-state at the wake time by employing the activation controller to turn the vehicle controller from the powered-off state to the powered-on state.

In some embodiments, the on-state includes an idle state.

In some embodiments, the method includes powering only the activation controller when the electric vehicle is in the off state.

In some embodiments, storing the wake time in the activation controller is performed by the vehicle controller when in the powered-on state.

In some embodiments, storing the wake time in the activation controller is based on a user designated time.

In some embodiments, the method includes, upon being turned to the powered-on state by the activation controller at the wake time based on the user designated time, initiating the vehicle controller to perform a vehicle operation corresponding to the user designated time.

In some embodiments, the vehicle operation comprises a battery preconditioning operation of a high-voltage battery of the electric vehicle.

In some embodiments, storing the wake time in the activation controller is based on a wake interval.

In some embodiments, the method includes, upon expiration of the wake interval, the activation controller waking the electric vehicle from the off state to the on state by turning the vehicle controller from the powered-off state to the powered-on state, and initiating the vehicle controller to download to the activation controller user designated times from a memory remote to the electric vehicle, the user designated times entered remotely into the remote memory by a user when the electric vehicle is in the off state.

In some embodiments, the method includes, adjusting a duration of the wake interval over time based on user interaction with the electric vehicle, wherein the longer a time since a last user interaction with the electric vehicle, the longer the duration of the wake interval.

In some embodiments, the method includes continuously powering the activation controller from a low-voltage battery; powering the vehicle controller from a high-voltage battery; and charging the low-voltage battery from the high voltage battery when the electric vehicle is in the on state.

In some embodiments, storing the wake time in the activation controller is based on a battery charging interval.

In some embodiments, the method includes, upon expiration of the battery charging interval, the activation controller waking the electric vehicle from the off state to the on state by turning the vehicle controller from the powered-off state to the powered-on state, and initiating the vehicle controller to perform a charging operation of the low-voltage battery from the high-voltage battery.

In some embodiments, the method includes resetting the battery interval each time the electric vehicle transitions from the on state to the off state.

One example provides an electrical system for an electric vehicle, the electrical system including an electric motor for propelling the vehicle, a vehicle controller for controlling operation of the electric vehicle, a high-voltage (HV) battery to power the electric vehicle, including the electric motor and vehicle controller, a low-voltage (LV) battery having a lower voltage than the HV battery, and an activation controller powered from the LV battery. At a wake time stored by the activation controller, the activation controller to provide an activation signal to transition the electric vehicle from an off-state, in which the HV battery is electrically disconnected from the electric motor and the vehicle controller, to an active state, where at least the vehicle controller is electrically connected to and powered from the HV battery.

Additional and/or alternative features and aspects of examples of the present technology will become apparent from the following description and the accompanying drawings.

### BRIEF DESCRIPTION OF THE DRAWINGS

FIG. 1 generally illustrates a side plan view of an electric snowmobile, according to one example.

FIG. 2 generally illustrates a side plan view of the electric snowmobile of FIG. 1 with several body panels removed, according to one example.

FIG. 3 generally illustrates a perspective view of a mid-bay of the electric snowmobile of FIG. 1, according to one example.

FIG. 4 is a block and schematic diagram generally illustrating portions of a control system and electric powertrain of an electric snowmobile when in an off-state, according to one example.

FIG. 5 is a flow diagram generally illustrating a process of operating an activation controller of an electric snowmobile, according to one example.

FIG. 6 is a block and schematic diagram generally illustrating portions of a control system and electric powertrain of an electric snowmobile when in a neutral state, according to one example.

FIG. 7 is a block and schematic diagram generally illustrating a system to enable a user to remotely communicate with an activation controller of an electric snowmobile, according to one example.

FIG. 8 is a flow diagram generally illustrating a process of operating an activation controller of an electric snowmobile, according to one example

FIG. 9 is a flow diagram generally illustrating a process of operating a body controller of an electric snowmobile, according to one example

FIG. 10 is a graph generally illustrating a wake duration curve, according to one example.

FIG. 11 is perspective view generally illustrating a user key and a start button of an electric snowmobile, according to one example.

FIG. 12 is a block and schematic diagram generally illustrating an activation controller of an electric snowmobile, according to one example.

FIG. 13 is a block and schematic diagram generally illustrating an activation controller of an electric snowmobile, according to one example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

EVs, including EPVs (such as snowmobiles, personal watercraft (PWCs), motorcycles, all-terrain vehicles (ATVs), utility terrain vehicles (UTVs), and side-by-sides (SxS), for example), employ rechargeable batteries to store energy to provide power to propel the vehicle and to power various electrical components and systems. When not in use, in order to minimize power consumption and extend battery life, EVs are typically placed in an inactive or standby state where only a limited vehicle functionality is enabled (e.g., unlocking doors). However, during extended periods of vehicle inactivity, which may be common for some types of EPVs (which tend to be used on a less frequent basis than automobiles, for example), the energy required to provide even limited functionality when in an off-state may unsatisfactorily deplete the batteries (e.g., below a useable level).

The present disclosure, as will described in greater detail herein, provides examples of an electrical control system and associated operating methods to provide initiation, including user-schedule initiation, of selected functionality for an EV when in an inactive or off-state with limited power draw from the battery. In examples, a low-power controller (an “activation controller”) is, at all-times, powered separately from a main battery of the vehicle (e.g., a high-voltage (HV) battery) by an ancillary battery (e.g., a low-voltage (LV) battery). In some examples, with the vehicle in the off-state, where only the activation controller is electrically powered (via the LV battery), the activation controller, in accordance with user entries in a task (or “wake-up”) schedule, transitions (or “wakes”) the vehicle from the off-state to an active state (e.g., a neutral state) by switching a vehicle controller (see below) from a powered-off state to a powered-on state (where the vehicle controller is powered from the HV battery), and initiates the vehicle controller to perform one or more vehicle operations or tasks designated by the corresponding user entry. In one example, such task may be a battery preconditioning operation where the vehicle controller directs a thermal management system of the vehicle to adjust a temperature of the HV battery to be within a predetermined temperature range.

In examples, a user may locally program (e.g., input or edit) entries into the task schedule via an instrument panel of the vehicle and/or remotely program entries, such as wirelessly via a cellphone (e.g., using a scheduling application) or other device, for instance. In some examples, the activation controller operates to intermittently wake the vehicle to perform tasks separate from the programmed entries of the task schedule, such as to check for remote communications and/or to charge the LV battery from the HV battery, for example. In other examples, the activation controller may wake the vehicle from the off-state in response to operation of an instrument panel device (such as a push-button or key switch, for example).

In accordance with the present disclosure, employing a low power activation controller, which is powered separately from the main HV battery by a LV battery, to wake the EV from an off-state based on programmed entries in a schedule or in response to user operation of an instrument panel device provides the EV with off-state functionality with limited power consumption from the HV battery.

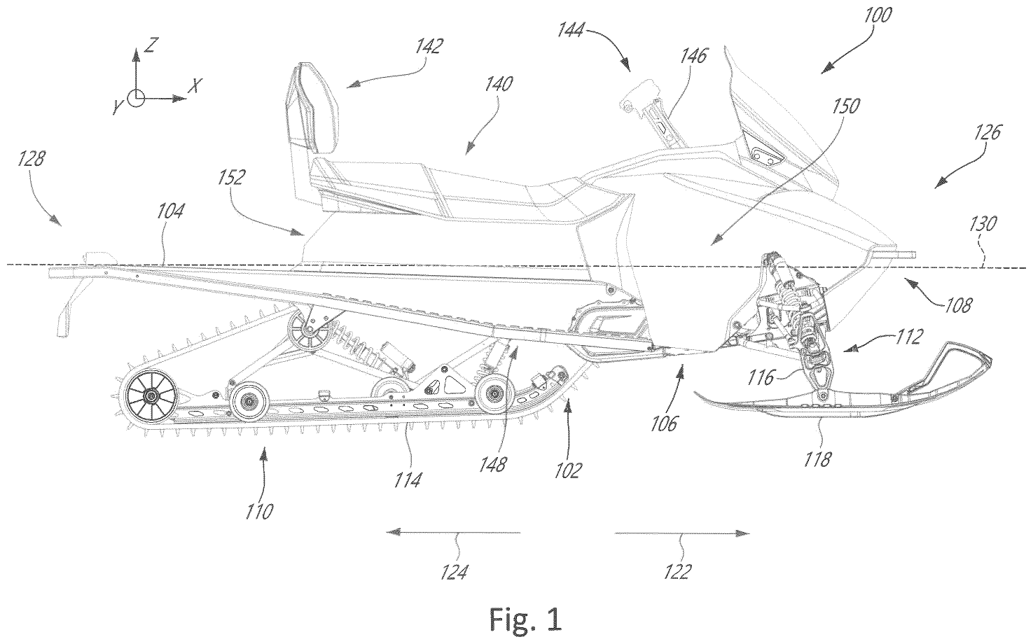

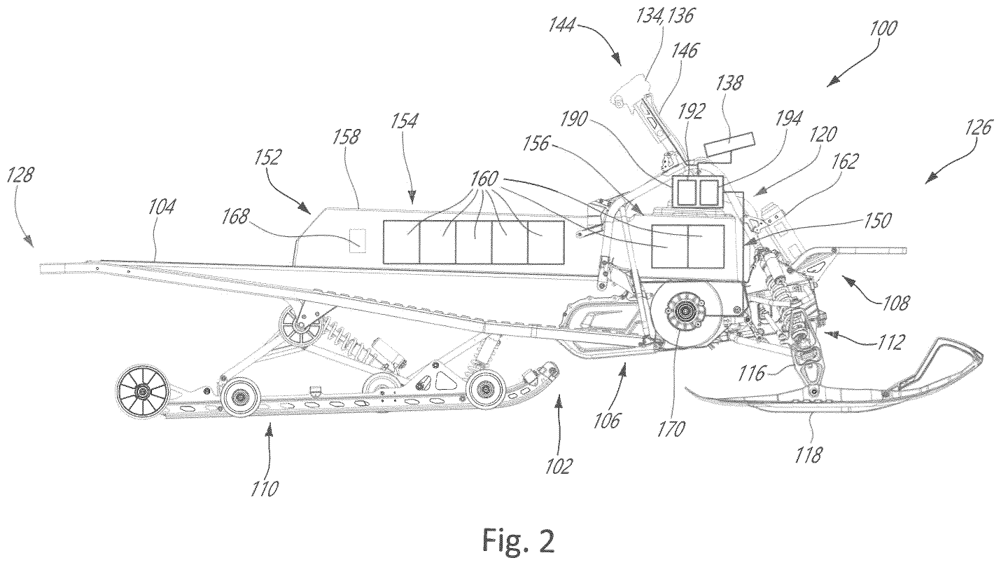

FIGS. 1-3 represent an example of an EV, in this case an EPV, and in particular, an electric snowmobile 100, employing a low power activation controller and operating methods, in accordance with the present disclosure. FIG. 1 illustrates a side plan view of snowmobile 100, according to an embodiment, and FIG. 2 illustrates another side plan view of the snowmobile 100 with several body panels and other components removed so that the interior of the snowmobile 100 may be viewed. The snowmobile 100 includes a frame 102, which may also be referred to as a “chassis” or “body”, which provides a load bearing framework for the snowmobile 1060. In the illustrated embodiment, the frame 102 includes a longitudinal tunnel 104, a mid-bay 106 (or “bulkhead”) coupled forward of the tunnel 104, and a front sub-frame 108 (or “front brace”) coupled forward of the mid-bay 106. In some implementations, the mid-bay 106 may form part of the front sub-frame 108.

The snowmobile 100 also includes a rear suspension assembly 110 and a front suspension assembly 112 to provide shock absorption and improve ride quality. The rear suspension assembly 110 may be coupled to the underside of the tunnel 104 to facilitate the transfer of loads between the rear suspension assembly 110 and the tunnel 104. The rear suspension assembly 110 supports a drive track 114 having the form of an endless belt for engaging the ground (e.g., snow) and propelling the snowmobile 100. The rear suspension assembly may include, inter alia, one or more rails and/or idler wheels for engaging with the drive track 114, and one or more control arms and damping elements (e.g., elastic elements such as coil and/or torsion springs forming a shock absorber) connecting the rails to the tunnel 104. The front suspension assembly 112 includes two suspension legs 116 coupled to the front sub-frame 108 and to respective ground engaging front skis 118 (only one suspension leg 116 and ski 118 are visible in FIGS. 1 and 2). Each of the suspension legs 116 may include two A-frame arms connected to the front sub-frame 108, a damping element (e.g., an elastic element) connected to the front sub-frame 108, and a spindle connecting the A-frame arms and the damping element to a respective one of the skis 118. The suspension legs 116 transfer loads between the skis 118 and the front sub-frame 108. In the illustrated embodiment, the frame 102 also includes an over structure 120 (shown in FIG. 2), that may include multiple members (e.g., tubular members) interconnecting the tunnel 104, the mid-bay 106 and/or the front sub-frame 108 to provide additional rigidity to the frame 102. However, as discussed elsewhere herein, the over structure 120 may be omitted in some embodiments.

The snowmobile 100 may move along a forward direction of travel 122 and a rearward direction of travel 124 (shown in FIG. 1). The forward direction of travel 122 is the direction along which the snowmobile 100 travels in most instances when displacing. The rearward direction of travel 124 is the direction along which the snowmobile 100 displaces only occasionally, such as when it is reversing. The snowmobile 100 includes a front end 126 and a rear end 128 defined with respect to the forward direction of travel 122 and the rearward direction of travel 124. For example, the front end 126 is positioned ahead of the rear end 128 relative to the forward direction of travel 122. The snowmobile 100 defines a longitudinal center axis 130 that extends between the front end 126 and the rear end 128. Two opposing lateral sides of the snowmobile 100 are defined parallel to the center axis 130. The positional descriptors “front”, “rear” and terms related thereto are used in the present disclosure to describe the relative position of components of the snowmobile 100. For example, if a first component of the snowmobile 100 is described herein as being in front of, or forward of, a second component, then the first component is closer to the front end 126 than the second component. Similarly, if a first component of the snowmobile 100 is described herein as being behind, or rearward of, a second component, then the first component is closer to the rear end 128 than the second component. The snowmobile 100 also includes a three-axes frame of reference that is displaceable with the snowmobile 100, where the Z-axis is parallel to the vertical direction, the X-axis is parallel to the center axis 130, and the Y-axis is parallel to the lateral direction.

The snowmobile 100 is configured to carry one or more riders, including a driver (sometimes referred to as an “operator”) and optionally one or more passengers. In the illustrated example, the snowmobile 100 includes a straddle seat 140 to support the riders. Optionally, the straddle seat 140 includes a backrest 142. The operator of the snowmobile 100 may steer the snowmobile 100 using a steering mechanism 144 (e.g., handlebars), which are operatively connected to the skis 118 via a steering shaft 146 to control the direction of the skis 118. The tunnel 104 may also include or be coupled to footrests 148 (also referred to as “running boards”), namely left and right footrests each sized for receiving a foot of one or more riders sitting on the straddle seat 140.

Referring to FIG. 2, the snowmobile 100 is electrically propelled by an electric powertrain 150. The powertrain 150 includes an electric battery 152 (also referred to as a “battery pack”) and an electric motor 170. The battery 152 is electrically connected to the motor 170 to provide electric power to the motor 170. The motor 170, in turn, is drivingly coupled to the drive track 114 to propel the snowmobile 100 across the ground. In other embodiments, the snowmobile 100 may also or instead be propelled by a powertrain including an internal combustion engine. For example, the motor 170 may also or instead be an internal combustion engine.

The battery 152 may include a battery enclosure 158 that houses one or more battery modules 160. The battery enclosure 158 may support the battery modules 160 and protect the battery modules 160 from external impacts, water and/or other hazards or debris. Each battery module 160 may contain one or more battery cells, such as pouch cells, cylindrical cells and/or prismatic cells, for example. In some implementations, the battery cells are rechargeable lithium-ion battery cells. The battery 152 may also include other components to help facilitate and/or improve the operation of the battery 152, including temperature sensors to monitor the temperature of the battery cells, voltage sensors to measure the voltage of one or more battery cells, current sensors to implement column counting to infer the state of charge (SOC) of the battery 42, and/or thermal channels that circulate a thermal fluid to control the temperature of the battery cells. In some implementations, the battery 152 may output electric power at a voltage of between 300 and 800 volts, for example. The snowmobile 100 may also include a charger 162 to convert AC to DC current from an external power source to charge the battery 152. The charger 162 may include, or be connected to, a charging port positioned forward of the straddle seat 140 to connect to a charging cable from an external power source. In some implementations, the charging port is covered by one or more protective flaps (e.g., made of plastic and/or rubber) to protect the charging port from water, snow and other debris.

In some implementations, the battery 152 may be generally divided into a tunnel battery portion 154 and a mid-bay battery portion 156. The tunnel battery portion 154 may be positioned above and coupled to the tunnel 104. As illustrated, the straddle seat 140 is positioned above the tunnel battery portion 154 and, optionally, the straddle seat 140 may be supported by the battery enclosure 158 and/or internal structures within the battery 152. The mid-bay battery portion 156 extends into the mid-bay 106 and may be coupled to the mid-bay 106 and/or to the front sub-frame 108. The tunnel battery portion 154 and the mid-bay battery portion 156 may share a single battery enclosure 158, or alternatively separate battery enclosures. In the illustrated example, the tunnel battery portion 154 and the mid-bay battery portion 156 each include multiple battery modules 160 that are arranged in a row and/or stacked within the battery enclosure 158.

It should be noted that other shapes, sizes and configurations of the battery 152 are contemplated. For example, the battery 152 may include multiple batteries that are interconnected via electrical cables. In some embodiments, the battery enclosure 158 may be a structural component of the snowmobile 100 and may form part of the frame 102. For example, the battery enclosure 158 may be coupled to the front sub-frame 108 to transfer loads between the front sub-frame 108 and the tunnel 104. The battery enclosure 158 may be formed from a fiber composite material (e.g., a carbon fiber composite) for additional rigidity. Optionally, in the case that the battery enclosure 158 is a structural component of the snowmobile 100, the over structure 120 may be omitted.

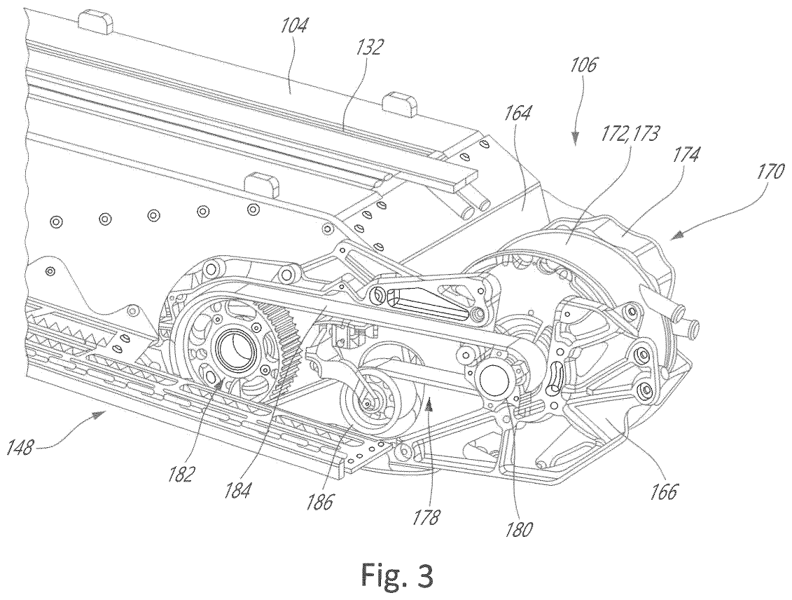

FIG. 3 is a perspective view of the mid-bay 106 of the snowmobile 100. As illustrated, the motor 170 is disposed in a lower portion of the mid-bay 106, below the mid-bay battery portion 156 and forward of a wall 164 defining a front end of the tunnel 104. The motor 170 may be mounted to a transmission plate 166 that is supported between the tunnel 104 and the front sub-frame 108 to help support the motor 170 within the mid-bay 106.

In the illustrated embodiment, the motor 170 is a permanent magnet synchronous motor having a rotor 172 and stator 173. The motor 170 also includes power electronics module 174 (sometimes referred to as an inverter) to convert the direct current (DC) power from the battery 152 to alternating current (AC) power having a desired voltage, current and waveform to drive the motor 170. In some implementations, the power electronics module 174 may include one or more capacitors to reduce the voltage variations between the high and low DC voltage leads, and one or more electric switches (e.g., insulated-gate bipolar transistors (IGBTs)) to generate the AC power. In some implementations, the motor 170 has a maximum output power of between 90 kW and 135 kW. In other implementations, the motor 170 has a maximum output power greater than 135 kW.

In some implementations, the motor 170 may include sensors configured to sense one or more parameters of the motor 170. The sensors may be implemented in the rotor 172, the stator 173 and/or the power electronics module 174. The sensors may include a position sensor (e.g., an encoder) to measure a position and/or rotational speed of the rotor 172, and/or a speed sensor (e.g., a revolution counter) to measure the rotational speed of the rotor 172. Alternatively or additionally, the sensors may include a torque sensor to measure an output torque from the motor 170 and/or a current sensor (e.g., a Hall effect sensor) to measure an output current from the power electronics module 174.

Other embodiments of the motor 170 are also contemplated. For example, the power electronics module 174 may be integrated into the housing or casing of motor 170, as shown in FIG. 3. However, the power electronics module 174 may also, or instead, be provided externally to the housing or casing of motor 170. In some embodiments, the motor 170 may be a type other than a permanent magnet synchronous motor. For example, the motor 170 may instead be a brushless direct current motor.

The motor 170 may convert the electric power output from the battery 152 into motive power that is transferred to the drive track 114 via a drive transmission 178. The drive transmission 178 engages with a motor drive shaft 180 of the motor 170. The motor drive shaft 180 may extend laterally through an opening in the transmission plate 166. The drive transmission 178 includes a track drive shaft 182 that extends laterally across the tunnel 104. The motor drive shaft 180 and the track drive shaft 182 may extend parallel to each other along transverse axes of the snowmobile 100 and may be spaced apart from each other along the longitudinal axis 130. In the illustrated embodiment, the motor drive shaft 180 is operably coupled to the track drive shaft 182 via a drive belt 184. Sprockets on the motor drive shaft 180 and the track drive shaft 182 may engage with lugs on the drive belt 184. A drive belt idler pulley 186 may also be implemented to maintain tension on the drive belt 184. In other embodiments, another form of linkage such as a drive chain, for example, may operatively connect the motor drive shaft 180 and the track drive shaft 182.

In operation, torque from the motor 170 is transferred from the motor drive shaft 180 to the track drive shaft 182 via the drive belt 184. The track drive shaft 182 includes one or more sprockets (not shown) that engage with lugs on the drive track 114, thereby allowing the track drive shaft 182 to transfer motive power to the drive track 114. It will be understood that the motor 170 may be operated in two directions (i.e., rotate clockwise or counter-clockwise), allowing the snowmobile 100 to travel in the forward direction of travel 122 and in the rearward direction of travel 124. In some implementations, the drive track 114 and the snowmobile 100 may be slowed down via electrical braking (e.g., regenerative braking) implemented by the motor 170 and/or by a mechanical brake (e.g., a disc brake) connected to one of the track drive shaft 182 or the motor drive shaft 180.

The snowmobile 100 may include a heat exchanger 132 that is coupled to, or integrated with, the tunnel 104. The heat exchanger 132 may form part of a thermal management system to control the temperature of the battery 152, the motor 170 and the charger 162, for example. The heat exchanger may include channels to carry a thermal fluid along a portion of the tunnel 104. During operation of the snowmobile 100, the heat exchanger 132 may be exposed to snow and cold air circulating in the tunnel 104 that cools the thermal fluid. The thermal fluid may then be pumped through thermal channels in the battery 152, the motor 170 and/or the charger 162, for example, to cool those components. In some implementations, the thermal management system of the snowmobile 100 may also include a heater 168 (shown in FIG. 2B) to heat the thermal fluid and warm the battery 152. Warming the battery 152 may be useful if the snowmobile 100 has been left for an extended period in a cold environment. In such a case, the temperature of the battery cells in the battery modules 160 may fall to a level where high power is limited from being drawn from the battery 152. Warming the battery 152 may bring the battery cells back into an efficient operating regime. In some implementations, the heater 168 is disposed within the battery enclosure 158.

Referring again to FIG. 2, one or more controllers 190 (referred to hereinafter in the singular) and an instrument panel 134 are part of a control system for controlling operation of the snowmobile 100. The instrument panel 134 allows an operator of the snowmobile 100 to generate user inputs and/or instructions for the snowmobile 100. The controller 190 is connected to the instrument panel 134 to receive the instructions therefrom and perform operations to implement those instructions. In the illustrated embodiment, the instrument panel 134 is provided on the steering mechanism 144 and the controller 190 is disposed within the interior of the snowmobile 100, but this need not always be the case.

The instrument panel 134 includes an accelerator 136 (also referred to as a “throttle”) to allow an operator to control the power generated by the powertrain 150. For example, the accelerator 136 may include a lever to allow the operator to selectively generate an accelerator signal. The controller 190 is operatively connected to the accelerator 136 and to the motor 170 to receive the accelerator signal and produce a corresponding output from the motor 170. In some implementations, the accelerator signal is mapped to a torque of the motor 170. When the controller 190 receives an accelerator signal from the accelerator 136, the controller 190 maps the accelerator signal to a torque of the motor 170 and controls the power electronics module 174 to produce that torque using feedback from sensors in the motor 50. The mapping of the accelerator signal to an output from the motor 170 may be based on a performance mode of the snowmobile 100 (e.g., whether the snowmobile 100 is in a power-saving mode, a normal mode or a high-performance mode). In some examples, the mapping of the accelerator signal to an output from the motor 170 may be based on current operating conditions of the powertrain 150 (e.g., temperature of the battery 152 and/or motor 170, state of charge of the battery 152, etc.). In still other examples, the mapping of the accelerator signal to an output from the motor 170 may be user configurable, such that a user may customize an accelerator position to motor output mapping.

In addition to the accelerator 36, the instrument panel 34 may include other user input devices (e.g., levers, buttons and/or switches) to control various other functionality of the snowmobile 100. These user input devices may be connected to the controller 190, which executes the instructions received from the user input devices. Non-limiting examples of such user input devices include a brake lever to implement mechanical and/or electrical braking of the snowmobile 100, a reverse option to propel the snowmobile 100 in the rearward direction of travel 124, a device to switch the snowmobile 100 between different vehicle states (e.g., “off”, “neutral” and “drive” states), a device to switch the snowmobile 100 between different performance modes, a device to switch between regenerative braking modes (e.g. “off”, “low” and “high” modes) and a device to activate heating of handgrips of the steering mechanism. The snowmobile 100 also includes a display screen 138 connected to the controller 190. The display screen 138 may be provided forward of the steering mechanism 144, or in any other suitable location depending on the design of the snowmobile 100. The display screen 138 displays information pertaining to the snowmobile 100 to an operator. Non-limiting examples of such information include the current state of the snowmobile 100, the current performance mode of the snowmobile 100, the speed of the snowmobile 100, the state of charge (SOC) of the battery 152, the angular speed of the motor 170, and the power output from the motor 170. The display screen 138 may include a liquid crystal display (LCD) screen, thin-film-transistor (TFT) LCD screen, light-emitting diode (LED) or other suitable display device. In some embodiments, display screen 138 may be touch-sensitive to facilitate operator inputs.

The controller 190 may also control additional functionality of the snowmobile 100. For example, the controller 190 may control a battery management system (BMS) to monitor the SOC of the battery 152 and manage charging and discharging of the battery 152. In another example, the controller 190 may control a thermal management system to manage a temperature of the battery 152, the motor 170 and/or the charger 162 using a thermal fluid cooled by the heat exchanger 132 and/or heated by the heater 168. Temperature sensors in the battery 152 and/or the motor 170 may be connected to the controller 190 to monitor the temperature of these components.

The controller 190 includes one or more data processors 192 (referred hereinafter as “processor 192”) and non-transitory machine-readable memory 194. The memory 194 may store machine-readable instructions which, when executed by the processor 192, cause the processor 192 to perform any computer-implemented method or process described herein. The processor 192 may include, for example, any type of general-purpose microprocessor or microcontroller, a digital signal processing (DSP) processor, an integrated circuit, an application-specific integrated circuit (ASIC), a field programmable gate array (FPGA), a reconfigurable processor, other suitably programmed or programmable logic circuits, or any combination thereof. The memory 194 may include any suitable machine-readable storage medium such as, for example, an electronic, magnetic, optical, electromagnetic, infrared, or semiconductor system, apparatus, or device, or any suitable combination thereof. The memory 194 may be located internally and/or externally to the controller 190.

Although the controller 190 is shown as a single component in FIG. 2, this is only an example. In some implementations, the controller 190 may include multiple controllers distributed at various locations in the snowmobile 100. For example, the controller 190 may include a vehicle control unit (also referred to as a “vehicle controller”) that is responsible for interpreting the inputs from various other controllers in the snowmobile 100. Non-limiting examples of these other controllers include a motor controller that is part of the power electronics module 174 and a battery management controller that is part of the BMS of battery 152. Optionally, separate battery management controllers may be implemented in the each of the battery modules 160 to form a distributed battery management system.

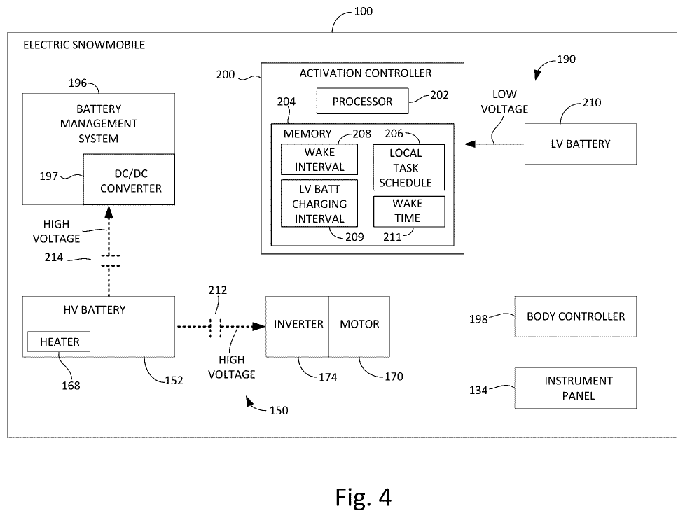

EVs, including EPVs, such as electric snowmobile 100, may have a number of different operating states. In examples, electric snowmobile 100 may have operating states including an off state, a neutral state (also referred to as an “idle” state or “wake” state), a drive state, and a charging state, where the neutral, drive, and charging states may together be referred to as “on” or “active” states, and the off state may be referred to as an “inactive” state. In contrast to EVs which are in frequent use, such as electric cars, for example, EPVs, such as electric snowmobile 100, may be inactive (in an off state) for extended periods of time. With this in mind, according to examples, when electrical snowmobile 100 is in the off state, which may be the lowest power mode (as illustrated by FIG. 4 below), battery 152 is disconnected from all electrical loads, including to electric motor 170/inverter 174 and controller 190.

In examples, when in the neutral state, controller 190 and other electrical components of electric snowmobile 100 may be powered from battery 152. Electric motor 170 and inverter 174 may, or may not, be powered in the neutral state but, in either case, electric motor 170 is disabled (e.g., will not operate in response to accelerator signals from accelerator 136). In some examples, when in the neutral state, controller 190 may maintain electric motor 170 in an idle state where capacitors in the inverter 174 are charged by battery 152 but switches in the inverter 174 are not operating, thereby maintaining electric motor 170 in a free-spinning state (e.g., a zero-torque state). In other examples, inverter 174 and motor 170 are not powered when in the neutral state (e.g., the inverter 174 is disconnected from battery 152 by contactors). While controller 190 may receive commands from accelerator 136, accelerator 136 is inactive in the neutral state (i.e., controller 190 does not respond to accelerator commands).

In examples, when in the drive state, controller 190, inverter 174/electric motor 170, and all subsystems are activated. Accelerator 136 is active, meaning that commands from accelerator 136 are converted to motor control commands by controller 190 and provided to inverter 174 for control of electric motor 170.

In examples, when in the charge state, battery 152 may receive power from external electric vehicle supply equipment (EVSE). Charger 162 may implement the charging (e.g., in the case of level 1 or level 2 charging), or battery 152 may be charged directly from the EVSE (e.g., level 3 or DC fast charging). Electric motor 170 and inverter 174 may, or may not, be powered in the charge state but, in either case, electric motor 170 is disabled (e.g., will not operate in response to accelerator signals from accelerator 136).

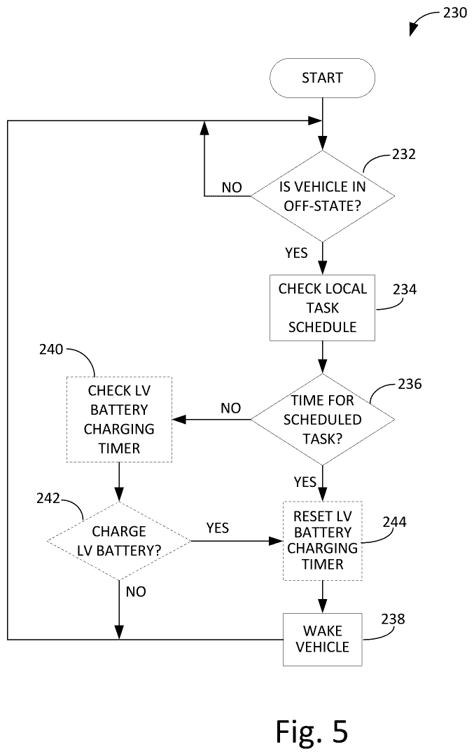

FIG. 4 is a block and schematic diagram generally illustrating portions of the control system and electric powertrain 150 of electric snowmobile 100 when electric snowmobile 100 is in the off state. Electric powertrain 150 includes battery 152 (also referred to herein as the high voltage (HV) battery 152), electric motor 170, and inverter 174. As described earlier, instrument panel 134 and controller 190 are part the control system for controlling operation of electric snowmobile 100. As also described earlier, snowmobile 100 may further include a battery management system (BMS), illustrated as battery management system 196, which may be controlled by controller 190 to monitor the SOC of the battery 152 and manage charging and discharging of the battery 152. In examples, as illustrated, BMS 196 includes a DC/DC converter 197 to convert a higher DC voltage of HV battery 152 to a lower DC voltage (e.g., 12 volts) which, as described in greater detail below, may be used to power low-voltage electrical components of snowmobile 100 (e.g., see FIG. 5).

In accordance with one example, as illustrated, controller 190 is implemented to include at least a body controller 198 and an activation controller 200, where activation controller 200 includes one or more processors, illustrated as processor 202, and a memory 204. In examples, as described below, body controller 198 may be referred to as a main vehicle controller (or simply as vehicle controller 198).

In examples, memory 204 stores a local task schedule 206 which, as will be described in greater detail below, includes user-programmed entries, with each entry designating a user requested task or operation to be performed by snowmobile 100 and/or a corresponding time (a “wake” time) at which the designated task is to be performed. In examples, local task schedule 206 might include only a designated wake time for body controller 198, where the task or operation to be performed is stored at body controller 198.

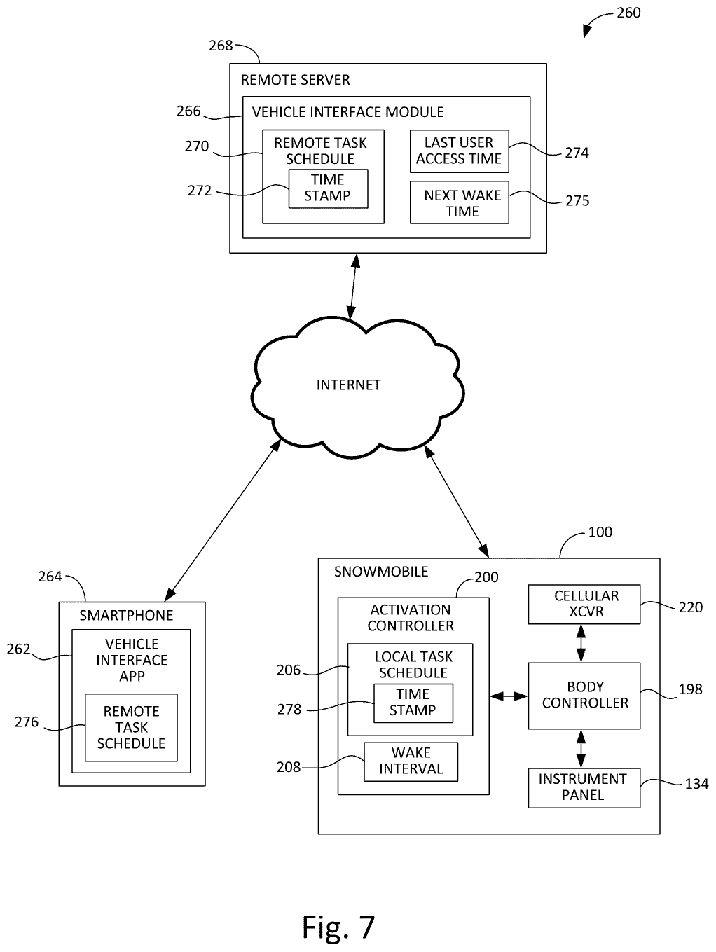

In some examples, as will be described in greater detail below (e.g., see FIGS. 7-10), memory 204 stores a wake interval (or duration) 208 which is employed by activation controller 200 to intermittently wake electric snowmobile 100 from the off-state to check for remote user communications which may modify local task schedule 206 (e.g., remove and/or modify existing schedule entries, and addition of new schedule entries). In examples, remote schedule modifications may be made via an application installed on any number of various computing devices, such as a cellphone, or personal computer, for example.

In examples, as illustrated, low-power activation controller 200 is, at all-times, powered from a low-voltage (LV) battery 210 which is separate from HV battery 152. In examples, LV battery 210 may have a lower voltage than HV battery 152. LV battery 210 may have a smaller physical size and weight than HV battery 152 and be considered an ancillary battery used to power auxiliary systems or devices of electric snowmobile 100 but not used directly for propulsion of electric snowmobile 100. LV battery 210 may have a smaller energy storage capacity than HV battery 152, and may be configured to output electric power at a voltage of 12 volts, for example. LV battery 210 may be a rechargeable lithium-ion, lead acid, or other type of rechargeable battery.

With continued reference to FIG. 4, when snowmobile 100 is in the off-state, HV battery 152 is electrically disconnected from any (or all) electric components of electric snowmobile 100. In one example, disconnecting HV battery 152 from electric motor 170/inverter 174 is achieved by opening a contactor 212 operatively disposed between HV battery 152 and inverter 174 so as to interrupt a high voltage (HV) connection there between (with the dashed lines indicating that the HV connection is de-energized). In some examples, contactor 212 may be included as part of inverter 174. In one example, HV battery 152 is electrically disconnected from any (or all) low voltage electrical loads by opening a contactor 214 operatively disposed between HV battery 152 and DC/DC converter 197 of BMS 196 so as to interrupt a high voltage (HV) connection there between (with the dashed lines indicating that the HV connection is de-energized). In some examples, contactor 214 may be included as part of DC/DC converter 197.

When in the off-state, activation controller 200 is powered from LV battery 210, and may be the only (sole) controller (or, more generally, only electric component) of electric snowmobile 100 which is energized. According to examples of the present disclosure, when electric snowmobile 100 is in the off-state, activation controller 200 monitors user entries in local task schedule 206, where each entry designates an user-scheduled operation (or task) to be performed by snowmobile 100 and/or a corresponding wake time at which the designated operation is to be performed (or a time from which the wake time may be derived). In examples, local task schedule 206 might only store a wake time for body controller 198 and, upon being woken-up, body controller 198 may determine and perform the user-scheduled operation.

In examples, a user may program (e.g., input and/or edit) entries in local task schedule 206 via instrument panel 134. In other examples, as described in greater detail below, a user may remotely program entries in local task schedule 206, such as via an application installed on any number of various computing devices, such as a cellphone, or personal computer, for example. In examples, the user entries in local task schedule 206 may designate or be associated with any number of tasks (operations) that may be performed by electric snowmobile 100.

For example, in one case, a user entry may designate a departure time for when the user expects to next use the electric snowmobile 100 (a so-called trip schedule entry). Based on the designated departure time, activation controller 200 may derive a “wake” time (e.g., 20, 30, 40, 50, 60 minutes prior to the user-entered departure time) at which activation controller 200 wakes snowmobile 100 from the off-state and instructs body controller 198 to perform a preconditioning operation to adjust a temperature of HV battery 152 to be within a selected temperature range for improved electrical performance of HV battery 152 at the designated departure time (e.g., heat HV battery 152 via heater 168 of the thermal management system). In another example, a user entry in local task schedule 206 may designate a time at which to perform a battery status check of various operating parameters of HV battery 152 (e.g., SOC, voltage level(s), etc.), where the various operating parameters may be provided to the user(s) by snowmobile 100 via the application installed on the remote device(s).

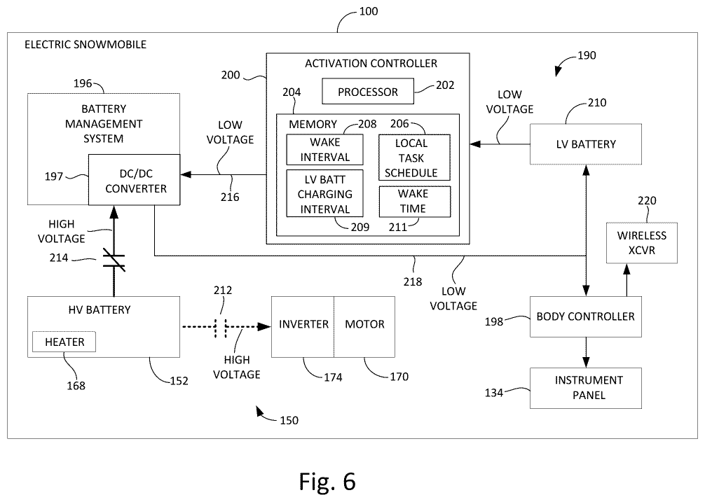

FIGS. 5 and 6 generally illustrate an example of the operation of activation controller 200 in transitioning (waking) electric snowmobile 100 from the off state to an active state (e.g., the neutral state) based on user entries in local task schedule 206. FIG. 5 is a flow diagram generally illustrating a process 230 of operating activation controller 200, according to one example. FIG. 6 is a block and schematic diagram generally illustrating portions of the control system and electric powertrain 150 of electric snowmobile 100 in an active mode, in this case the neutral state, after being transitioned (“wakened”) from the off-state to the neutral state by activation controller 200 based user entries of local task schedule 206.

Referring to FIG. 5, process 230 begins at 232 where activation controller 200 queries whether snowmobile 100 is in the off-state. If the answer is “no”, snowmobile 100 is an active state (e.g., neutral, drive, charging), and process 230 continues querying whether snowmobile 100 is in the off state. If the answer is “yes”, process 230 proceeds to 234.

At 234, controller 200 checks user entries in local task schedule 206 and proceeds to 236. At 236, controller 200 queries whether a designated wake-up time of a user entry in local task schedule 206 coincides with the current time (i.e., the date & time). If the answer is “no”, according to one example, process 230 may return to 232 or, optionally, proceed to 240. If the answer is “yes”, meaning that it is time for electric snowmobile 100 to perform a user scheduled task, process 230, according to one example, proceeds to 238 via 244, which is described below. At 238, activation controller 200 provides an activation signal (or “power on” signal) to transition (or “wake”) electric snowmobile 100 from the off state to an active state (e.g., the neutral state), whereby body controller 198 is powered on, such as via a low-voltage DC output (e.g., 12 VDC) of DC/DC converter 197 of BMS 196. Additionally, at 238, activation controller 200 may provide an initiation signal to body controller 198 to initiate performance of the task corresponding to the user entry. Initiation of the task may instead be determined based on a schedule stored by body controller 198. In examples, the activation and/or initiation signals may be communicated via a suitable controller area network (CAN) or other type of data bus.

With reference to FIG. 6, as described at 238 in FIG. 5, according to one example, when the response to the query at 236 is “yes”, activation controller 200 provides an activation (or “power on”) signal 216 to DC/DC converter 197. In response to activation signal 216, DC/DC converter is activated and connected to HV battery 152, such as via closure of contactor 214, and converts the high voltage output of HV battery 152 to a low voltage DC output 218 which power various components of electric snowmobile 100. In examples, during the transition from the off state to the neutral state, DC/DC converter 197 may be powered by the LV battery 210. In examples, once electric snowmobile 100 is transitioned to the active state, DC/DC converter 197 may be powered by its own low voltage output, or continue to be power from LV battery 210. As illustrated by FIG. 6, once transitioned to the active state (e.g., the neutral state), low voltage DC output 218 from DC/DC converter 197 powers low voltage components of electric snowmobile 100, such as body controller 198, and may be used to charge LV battery 210 (when LV battery 210 is powering activation controller 200 and, in some examples, powering DC/DC converter 197). In examples, LV battery 210 is charged via low voltage DC output 218 from DC/DC converter 197 each time electric snowmobile 100 is in an active mode. In examples, body controller 198 may additionally connect instrument panel 134 and wireless transceiver device 220 to low voltage DC output 218.

In the illustrated example, contactor 212 is shown as being open in the neutral state, which disconnects inverter 174 and electric motor 170 from HV battery 152. Contactor 212 may be closed when electric snowmobile 100 switches to the drive state to provide HV power to inverter 174 and electric motor 170. In other examples, contactor 212 is closed in the neutral state to connect inverter 174 and electric motor 170 to HV battery 152.

Returning to FIG. 5, in one example, after providing the activation (power on) and initiation signals at 238, process 230 returns to 232 to continue monitoring local task schedule 206 upon electric snowmobile 100 returning to the off state.

With continued reference to FIG. 5, in other examples, in addition to monitoring the user entries of local task schedule 206, activation controller additionally monitors LV battery charging interval 209 to determine whether LV battery 210 is to be charged. In one example, the LV battery charging interval 209 is a predetermined time duration (e.g., 2 weeks). In one example, LV battery charging interval 209 is a factory set duration (which may be adjustable by certified technicians). In other examples, LV battery charging interval 209 may be a user entered value (e.g., via instrument panel 134).

According to such implementation, when the answer to the query at 236 is “no”, in lieu of returning 232, process 230 proceeds to 240, where activation controller 200 checks a value of a LV charging timer operated by activation controller 200. Process 230 then proceeds to 242 where it is queried whether LV battery charging interval 209 has been reached. If the answer at 242 is “no”, process 230 returns to 232. If the answer at 242 is “yes”, process 230 proceeds to 244, where the LV charging timer is reset, and then to 238 where, as described above, activation controller 200 provides activation signal 216 to DC/DC converter 197 to wake electric snowmobile 100 from the off state to the active state, and provides an initiation signal to body controller 198, in this case, to perform a charging operation of LV battery 210.

According to such scenario, when the answer at 236 is “yes”, process 230 may also reset the LV charging timer at 244 before continuing to 238 where, as described above, activation controller 200 provides activation signal 216 to DC/DC converter 197 and the initiation signal to body controller 198 to perform the task designated by the user entry in local task schedule 206.

As mentioned above, in examples, in addition to programming user entries in local task schedule 206 via instrument panel 134, users may remotely program (e.g., input and/or edit) entries in local task schedule 206. In examples, such remote user entries may be made via an application installed on any number of various computing devices, such as a cellphone, or personal computer, for example.

FIG. 7 is a block and schematic diagram generally illustrating a system 260 which enables a user to remotely program user entries in local task schedule 206 of activation controller 200 of electric snowmobile 100. In one example, in addition to electric snowmobile 100, system 260 includes a vehicle interface application 262 installed on a computing device, such as smartphone 264, and a vehicle interface module 266 residing on a remote server 268. In examples, electric snowmobile 100, smartphone 264, and remote server 268 are each connected to, and communicate with one another, via the Internet.

Vehicle interface application 262, and the associated functions described herein, may be implemented by computer-readable instructions stored in memory of smartphone 264 and executable by processors of smartphone 264. Alternatively or additionally, vehicle interface application 262 may be a cloud-based application accessed via an internet browser on smartphone 264. The vehicle interface module 266 may be implemented by memory and processors residing in remote server 268, where the memory stores computer-readable instructions that are executed by the processors to perform the functions of the vehicle interface module 266 described herein. Examples of memory and processors are provided elsewhere herein.

In one example, vehicle interface module 266 includes a remote task schedule 270, where remote task schedule 270 represents a version of local task schedule 206 residing on activation controller 200, and includes a time stamp 272 indicating the time of the most recent update of remote task schedule 272. In one example, vehicle interface module 266 includes a user access log indicating the time of the last access 274 of vehicle interface module 266 by a user (e.g., via a computing device, such as smartphone 264). Vehicle interface application 262 also includes a version of local task schedule 206, indicated as remote task schedule 276. Additionally, local task schedule 206 residing on activation controller 200 includes a time stamp 278 indicating the time of the most recent update of local task schedule 206. Time stamp 278 may also or instead be stored by body controller 198.

In examples, because electric snowmobile 100 might not be continuously connected to remote server 268, such as when snowmobile 100 is in the off-state, when a user wishes to remotely add a new user entry and/or modify an existing user entry in local task schedule 206 via smartphone 264 (or other computing device), smartphone 264 connects to vehicle interface module 266 residing on remote server 268. In one example, upon connecting to remote server 268, the remote task schedule 276 of smartphone 276 is updated with remote task schedule 270 from vehicle interface module 270, at which point a user is able to make changes to remote task schedule 276 on smartphone 264. Upon the user completing updates to user entries in remote task schedule 276, the entries of remote task schedule 276 of smartphone 264 are uploaded to remote server 268 so that remote task schedule 270 of vehicle interface module 266 is synced with remote task schedule 276 of smartphone 264. In one example, time stamp 272 of remote task schedule 270 of vehicle interface module 266 on remote server 268 is updated to indicate the update time of remote task schedule 270. In one example, each time a user accesses vehicle interface module 266 via a vehicle interface app (such as vehicle interface app 262), even if modifications are not made to remote task schedule 270, vehicle interface module 266 updates the last user access time 274 of the user access log.

According to examples, to reduce energy consumption from HV battery 152, when electric snowmobile 100 is in the off-state, activation controller 200 is configured to intermittently wake snowmobile from the off-state to an active state (e.g. the neutral state) to cause body controller 198 to connect to remote server 268 to check for remote user communications that may have been made via vehicle interface app 262 of smartphone 264 to modify user entries of remote task schedule 270. In one example, if time stamp 272 of remote task schedule 270 is more recent than time stamp 278 of local task schedule 206, body controller 198 downloads remote task schedule 270 from vehicle interface module 266 to replace local task schedule 206 residing on activation controller 200 and updates time stamp 278 of local task schedule 206 to match time stamp 272 of remote task schedule 270. Conversely, if time stamp 278 of local task schedule 206 is more recent than time stamp 272 of remote task schedule 270 (e.g., a user may have updated local task schedule 206 via instrument panel 134), body controller 198 uploads local task schedule 206 from snowmobile 100 to vehicle interface module 266 to replace remote task schedule 270 and updates time stamp 272 of remote time schedule 270 to match time stamp 278 of local task schedule 278.

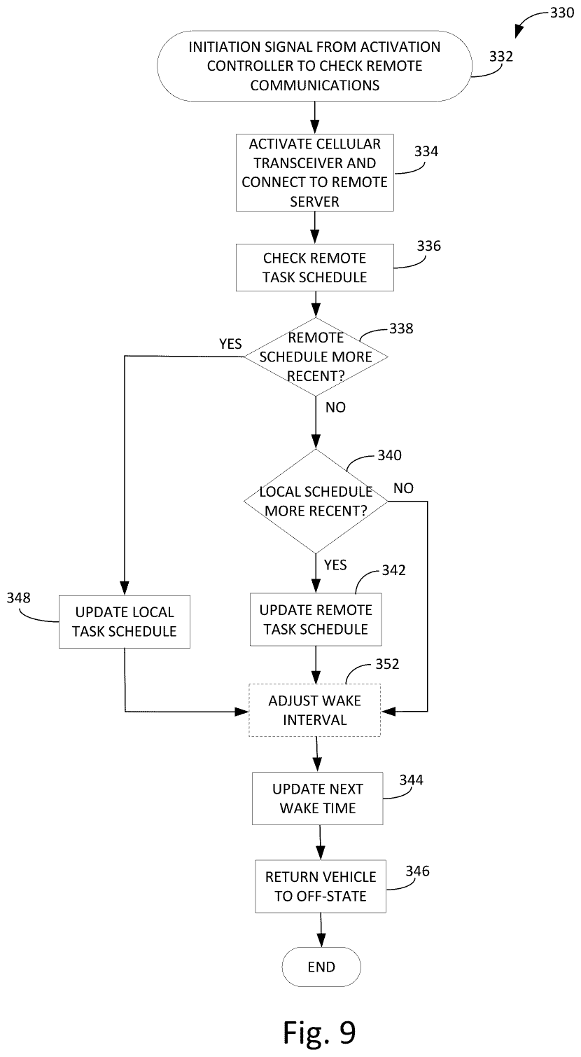

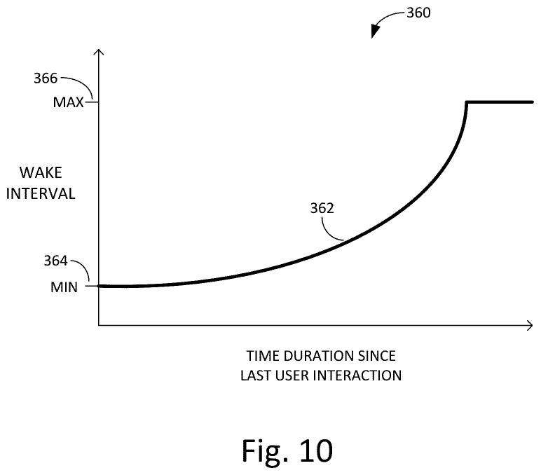

In examples, activation controller 200 intermittently wakes electric snowmobile 100 in accordance with wake interval 208. In some examples, wake interval 208 may be a fixed time duration (e.g., 1, 2, 4, 6, 12 or 24 hours). In other examples, as will be described in greater detail below (e.g., see FIGS. 9 and 10 below), wake interval 208 may vary over time (e.g., the wake interval may increase in duration with increasing time since a last user interaction with electric snowmobile 100 (e.g., via instrument panel 134 and/or via vehicle interface app 262).

In examples, when communicating with vehicle interface module 266 of remote server 268, body controller 198 uploads the next wake time (as indicated at 275) at which activation controller 200 will wake electric snowmobile 100 to connect to remote server 268 to check for remote user communications made with vehicle interface module 266 (e.g., modifications to remote schedule 270). Because activation controller 200 intermittently wakes electric snowmobile 100 to check for remote user communications based on wake up interval 208, it is possible that a user (via vehicle interface module 266 of remote server 268) may attempt to remotely add and/or modify a user entry for local task schedule 206 (e.g., via smartphone 264) that has a corresponding wake time that occurs prior to the next time activation controller 200 is to wake snowmobile 100, as indicated by the next wake time 275. In such case, according to examples, vehicle interface module 266 will not allow such modification to made to remote task schedule 270 and notifies the user that the wake time designated by the user entry to perform the corresponding operation is not possible. Additionally, vehicle interface module 266 may notify the user of the earliest time for which an operation can be remotely scheduled based on the next wake time 275, and also notify the user that such entry may be made to local task schedule 208 at electric snowmobile 100, such as via instrument panel 134.

In some embodiments, when activation controller 200 wakes electric snowmobile 100 (e.g., at 238 in FIG. 5), interface application 262 may notify the operator via smartphone 264. For example, a display screen of smartphone 264 may present a message to notify the operator that electric vehicle 100 is in an on state and capable of remote communication. In some implementations, when electric vehicle 100 communicates with server 268, server 268 may send a communication to smartphone 262 to notify the operator that electric vehicle 100 is in an on state. Alternatively, server 268 may user next wake time 275 to determine when electric vehicle 100 is in an on state and send a communication to smartphone 264 to notify the operator at this wake time. Further, vehicle interface application 262 may also store next wake time 275 and notify the operator when that wake time is reached.

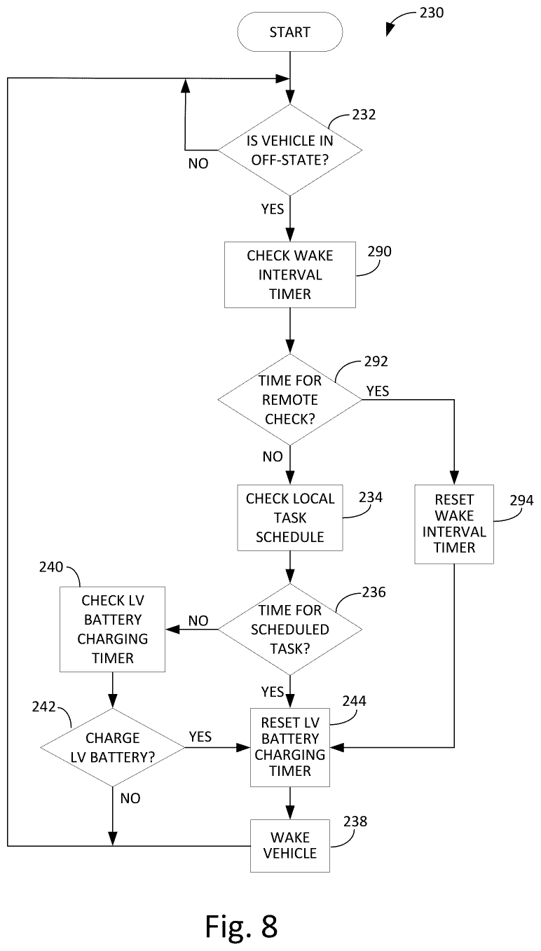

FIG. 8, with further reference to FIGS. 5 and 7, is a flow diagram illustrating process 230 of operating activation controller 200, according to one example, which further includes intermittently checking for remote user communications which may have modified local task schedule 206. The flow diagram of FIG. 8 is the same as that of FIG. 5, except that processes 290 and 292 are included between processes 232 and 234.

As illustrated, if the answer at 232 is “yes”, meaning that snowmobile 100 is in the off-state, process 230 proceeds to 290 where activation controller 292 checks a value of a wake interval timer maintained by activation controller 200. Process 230 then proceeds to 292 where it queries whether wake interval 208 has been reached. If the answer at 292 is “no”, process 230 proceeds to 234, where local task schedule 206 is checked (as described above by FIG. 5). If the answer at 292 is “yes”, process 230 proceeds to 294, where the wake interval timer is reset. Process 230 then proceeds to 244 where the LV charging timer is reset, and then to 238 where, as described above, activation controller 200 provides activation signal 216 to DC/DC converter 197 to wake electric snowmobile 100 from the off state to the active state, and provides an initiation signal to body controller 198, in this case, to perform a remote communications check (as illustrated by FIG. 9).

In some examples, memory 204 stores a wake time 211 that includes the next date and time when electric snowmobile 100 is scheduled to switch to an active state to perform a task (e.g., perform a user designated task, check for remote communications and/or charge LC battery 210). Wake time 211 may be programmable or reprogrammable based on the next scheduled wake up. For example, wake time 211 may be the next (closest or soonest) time defined in local task schedule 206, wake interval 208 and/or LV battery charging interval 209. The answers at 292, 236, 242 of FIG. 8 may each be determined based on wake time 211. Wake time 211 may correspond to next wake time 275 stored in vehicle interface module 266.

Optionally, memory 204 might store wake time 211, while body controller 198 stores local task schedule 206, wake interval 208 and/or LV battery charging interval 209. At each wake up scheduled by wake time 211, body controller 198 may search local task schedule 206, wake interval 208 and/or LV battery charging interval 209 to determine which task(s) is/are to be performed at that wake up. Before switching to an inactive state, body controller 198 may confirm that wake time 211 corresponds to the next time a task is scheduled, and reprogram wake time 211 based on times stored in local task schedule 206, wake interval 208 and/or LV battery charging interval 209 as required. Further, before switching to an inactive state, body controller 198 may confirm that next wake time 275 corresponds to the next time a task is scheduled, and reprogram next wake time 275 based on times stored in local task schedule 206, wake interval 208 and/or LV battery charging interval 209 as required.

FIG. 9 is a flow diagram generally illustrating a process 330 of operating body controller 198 to check for remote user communications which may be have occurred to make modifications to local task schedule 206 of activation controller 200. Process 330 begins at 332 upon receiving from activation controller 200 an initiation signal to check for remote user communications, such as initiated by an answer of “yes” to the query at 292 of process 230 of FIG. 8. Process 330 then proceeds to 334, where body controller 198 powers wireless transceiver 220, in this case, cellular transceiver 220, and connects to remote server 268. In other examples, not illustrated, connection to remote server 268 may be made via a WiFi transceiver which connects to the Internet and remote via connection to WiFi local network (such as via a WiFi router, e.g.).

At 336, after connecting to remote server 268, body controller 198 checks remote task schedule 270 of vehicle interface module 266 and proceeds to 338. At 338, body controller 198 queries whether time stamp 272 of remote task schedule 270 of vehicle interface module 266 is more recent than time stamp 278 of local task schedule 206 of activation controller 200. If the answer to the query at 338 is “no”, process 330 proceeds to 340.

At 340, body controller queries whether time stamp 278 of local task schedule 206 is more recent than time stamp 272 of remote task schedule 270. If the answer to the query at 340 is “yes”, meaning that local task schedule 206 has been more recently updated than remote task schedule 270 (e.g., via user entries made via instrument panel 134), process 330 proceeds to 342. At 342, body controller 198 uploads local task schedule 206 to remote server 268, where vehicle interface module 266 replaces remote task schedule 270 with local task schedule 206, including replacing remote time stamp 272 with local time stamp 278. In one example, process 330 then proceeds to 344, where body controller 198, based on wake interval 208, updates the next wake time 275 (i.e., the next time activation controller 200 will wake electric snowmobile 100 to check for remote communications). Process 330 then proceeds to 346, where body controller 198 returns electric snowmobile 100 to the off state.

If the answer to the query at 338 is “yes”, meaning that remote task schedule 270 is more recent than local task schedule 206, process 330 proceeds to 348. At 348, process 330 replaces local task schedule 206 with remote task schedule 270, including replacing local time stamp 278 with remote time stamp 272. In one example, process 330 then proceeds to 344 where, as described above, body controller 198 updates the next wake time 275, and then returns electric snowmobile 100 to the off state at 346.

According to one example, process 330 alternatively includes a process 352 (as indicated by dashed lines) which is carried out prior to body controller 198 updating the next wake time 275 stored at remote server 268 by vehicle interface module 266. In some examples, as described above, wake interval 208 may be a fixed time duration (e.g., 24 hours). According to alternative process 330, at 352, body controller 198 may vary the duration of wake interval 208 over time, such as based on a time duration since a user last interacted with electric snowmobile 100. In examples, such user interaction may be remote user interaction via vehicle interface application 262 (e.g., as logged by the most recent user access 274), may be direct user interaction via instrument panel 134 (e.g., when a user wakes snowmobile from the off state via actuation of buttons or other device of instrument panel 134), and/or may be the waking of snowmobile 100 from the sleep state to an active state by activation controller 200 in response to user entries in local task schedule 206.

In examples, wake interval 208 may begin at an initial value and be increased in value by body controller 198 based on an increasing time duration since the last user interaction (i.e., the longer the time duration since the last user interaction, the greater the value of wake interval 208). In one example, upon the next user interaction with snowmobile 100, body controller 198 may reset the value of wake interval 208 to the initial value.

FIG. 10 is a graph 360 illustrating a wake duration curve 362 representing one example of how body controller 198 may vary the value of wake interval 208 over time based on a time duration since a last user access of snowmobile 100. In one example, wake interval 208 begins with an initial/minimum value, as indicated at 364. As the time duration since the last user interaction increases in value, body controller increases the value of wake interval 208 until a maximum wake interval value 366 is reached. In one example, each time a user interaction occurs, body controller 198 resets the value of wake interval 208 to the initial value. In examples, the minimum and maximum wake interval values 364 and 366 may be fixed values (e.g., factory determined values) and/or user entered values (such as via instrument panel 134, for example). It is noted that any suitable technique, in addition to that described by FIG. 10, may be employed to vary the value (increase and/or decrease) of wake interval 208 over time. Extending the wake interval 208 may help save power for the snowmobile 100.

In some implementations, if a wireless signal is not available at the location of electric snowmobile 100, then cellular transceiver 220 might not be able connect to remote server 268. In such a case, then electric snowmobile 100 may attempt a direct connection to smartphone 264 via Bluetooth®, for example. Local task schedule 206 may then be updated based on operator input to vehicle interface application 262. In some implementations, electric snowmobile 100 may attempt a direct connection to smartphone 264 via Bluetooth® in addition to a connection to remote server 268.

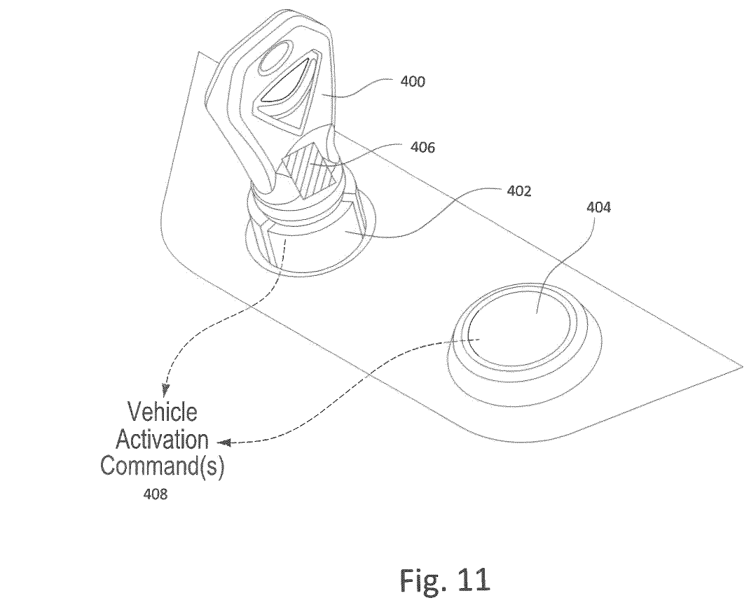

As illustrated by FIGS. 11-13 below, in some examples, in addition to waking electric snowmobile 100 in response to user entries in local task schedule 208, in response to the expiration of wake interval 208 (for checking for remote user communications), and/or in response to expiration of battery charging interval 209 (for charging of LV battery 210), activation controller 200 may permit operation of electric snowmobile 100 (e.g., transition snowmobile 100 from the off-state to an on-state, such as the neutral state) in response to local user inputs (e.g., via instrument panel 134). In this way, activation controller 200 may automatically wake up electric snowmobile 100 at a scheduled time and wake up electric snowmobile 100 when a user manually interacts with instrument panel 134. By performing both of these functions, activation controller 200 may be the sole controller active in the off state.

As shown in FIGS. 11-13, activation controller 200 may permit operation of electric snowmobile 100 in response to a user key 400 being received into a key receptacle 402 of electric snowmobile 100 (e.g., as part of instrument panel 134), or when key 400 is in sufficient proximity to electric snowmobile 100. Engagement of key 400 with receptacle 402 or the proximity of key 400 to electric snowmobile 100 may be communicated to activation controller 200 and/or to body controller 198 (when body controller 198 is activated) so that activation controller 200 and/or body controller 198 may authorize the activation and/or operation of electric snowmobile 100. The presence of key 400 in receptacle 402 or in proximity to electric snowmobile 100, and key 400 being valid, may indicate that the operation of electric snowmobile 100 is authorized.

Alternatively or in addition to the use of key 400, the presence of the user in proximity to electric snowmobile 100 and/or the authorization of the user to operate electric snowmobile 100 may be established by detecting the presence of a portable electronic device (PED), such as smartphone 264, which may be carried by the user. Such PED may be in wireless data communication (e.g., paired via Bluetooth®) with body controller 198 and/or with activation controller 200 to inform body controller 198 and/or activation controller 200 of the proximity of the user via the PED as a proxy. The use of key 400 and/or PED may be associated with a user identification and permit an authentication of the user to establish the user's authorization to operate electric snowmobile 100. Alternatively or in addition, the user's authorization to operate electric snowmobile 100 may be established by way of an authorization code or password that may be manually entered by the user via instrument panel 134 of electric snowmobile 100, or via a PED in communication with electric snowmobile 100, permitting the user to interact with and provide inputs to electric snowmobile 100.

A user interface of electric snowmobile 100, such instrument panel 134, may include one or more widgets for receiving input from the user. Such widgets may, for example, include rotary switches, toggle switches, push buttons, knobs, dials, etc. The widgets may include one or more physical (hard) devices and/or one or more graphical objects on a graphical user interface provided on a touch-sensitive display screen of electric snowmobile 100.

The user interface of electric snowmobile 100 may include start button 404 (e.g., a physical push button) or other input device(s) (e.g., rotary switch(es), multiple push buttons, receptacle 402 and key 400) suitable for generating one or more vehicle activation commands for transitioning electric snowmobile 100 from an inactive (i.e., off) state to an active (e.g., wake or ready) state explained further below. Start button 404 may be disposed on or close to handlebar 24 or at another suitable location that is accessible by the user. In some embodiments, a rotary switch (and optionally a key) may be suitable for generating a vehicle activation command for activating electric snowmobile 100 after a period of inactivity. Such rotary switch may include different angular positions corresponding to the different states of electric snowmobile 100 described herein.

FIG. 11 shows an exemplary representation of key 400 and of start button 404 associated with electric snowmobile 100. In some embodiments, key 400 may be part of a radio-frequency identification (RFID) system of electric snowmobile 100. Key 400 may include RFID tag 406 which may store data identifying key 400 or a specific user associated with key 400. When triggered by an electromagnetic interrogation pulse from a RFID reader device associated with electric snowmobile 100, RFID tag 406 may wirelessly transmit the data stored on RFID tag 406 and the data may be used by activation controller 200 and/or body controller 198 to authenticate key 400 and either permit or prevent the operation of electric snowmobile 100 based on the data. In some embodiments, key 400 may interact with a first software-based or physical/mechanical hardware-based switch disposed within receptacle 402 so that the insertion and withdrawal of key 400 into and out of receptacle 402 may cause key 400 to interface with and actuate such switch, and signal to activation controller 200 and/or body controller 198 the user's authorization to use electric snowmobile 100. In some embodiments, electric snowmobile 100 may include a (e.g., rotary) switch that is actuatable with key 400.

Start button 404 may be disposed in proximity to receptacle 402. Start button 404 may be operatively connected to activation controller 200 and may be used to generate one or more vehicle activation commands 408 that may be received at activation controller 200 and cause activation controller 200 to generate a suitable activation signal 216 for transitioning electric snowmobile 100 from the off-state to an active state, such as the neutral state, for example.

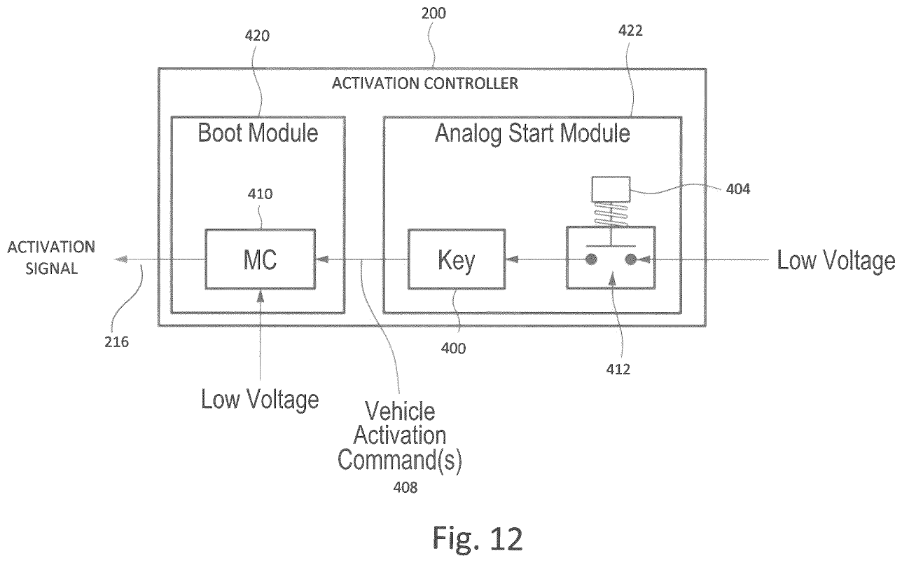

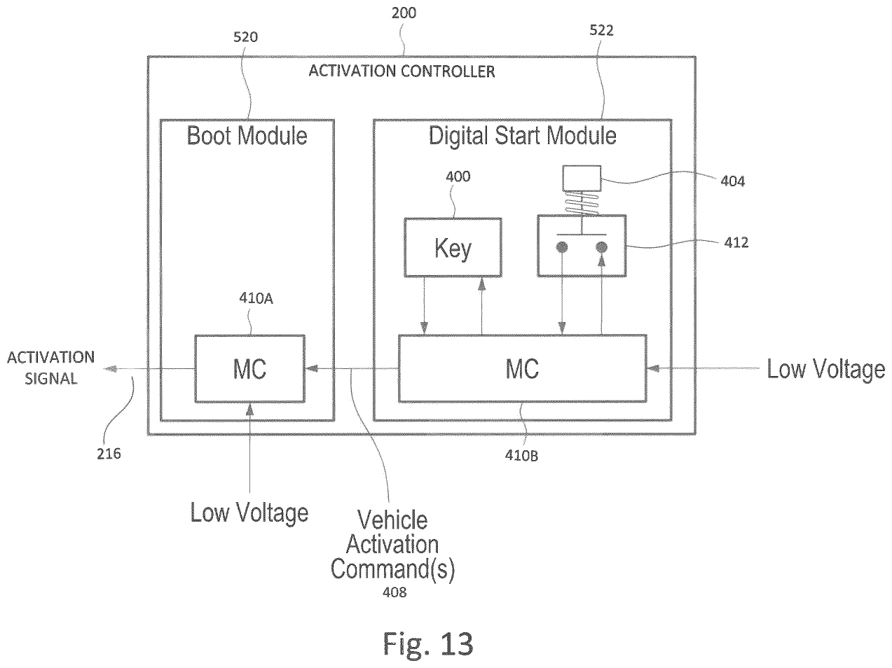

FIG. 12 is a schematic diagram of another exemplary activation controller 200. Activation controller 200 may include elements previously described with like elements being identified using like reference numerals. It is noted that for clarity of explanation, local task schedule 206 is not illustrated in FIG. 12 (nor in FIG. 13), but operates in addition to the operation of user key 400 and the example implementations of FIGS. 12 and 13. Activation controller 200 may include a boot module 420 operatively connected to an analog start module 422. Boot module 420 may include MC 410 (which may include or be in addition to processor 202) configured to monitor for the receipt of vehicle activation command 408 from analog start module 422. However, boot module 420 may instead have an analog implementation. In response to vehicle activation command 408, MC 410 may output activation signal 216 to cause transition of electric snowmobile 100 from the off-state to an active state, such as the neutral state. The single MC 410 may be the sole controller or sole electric load powered by LV battery 210 when electric snowmobile 100 is in the inactive state.

Vehicle activation command 408 may include a change from a lower voltage (e.g., zero volt) to a higher voltage (e.g., 12 volts) sensed at MC 410. Vehicle activation command 408 may be generated by analog start module 422 (which, in some examples, may be separate from activation controller 200). Analog start module 422 may function to establish an electrical connection between MC 410 and LV battery 210 when one or more conditions are met. For example, switch 412 may be operatively disposed between LV battery 210 and boot module 420. Switch 412 may be biased toward a normally-open configuration and may be actuatable by the user via start button 404 or other widget with which the user may interact (e.g., manipulate, actuate) to provide a user input. For example, start button 404 may be spring-loaded so that the momentary pressing of start button 404 may cause momentary closing of switch 412 to provide electric communication across switch 412.

In some embodiments, the presence of key 400 in receptacle 402 may be another condition to be met in order to generate vehicle activation command 408. The presence of key 400 in receptacle 402 may cause the closing of another switch (not shown) to establish electric communication between LV battery 210 and boot module 420. Alternatively, electric communication may be established across key 400 when key 400 is received in receptacle 402. Together, the presence of key 400 in receptacle 402 and the closing of switch 412 may provide an electric connection between LV battery 210 and MC 410 of boot module 420.

In examples, as described above, activation signal 216 generated by boot module 420 may initiate the operation of DC/DC converter 197. In some embodiments, MC 410 may also monitor the initiation of DC/DC converter 197 and may implement a timeout criterion where activation signal 216 is discontinued if DC/DC converter 197 did not start properly within a threshold time period. Discontinuing activation signal 216 may cease the initiation of DC/DC converter 197. In such situation, the transition of electric snowmobile 100 to the on state may be aborted and a suitable annunciation may optionally be provided to the user. In such situation, boot module 420 may then continue or resume monitoring for vehicle activation command 408.

Instead of, or in addition to start button 404 and key 400, one or more other (e.g., proximity) sensors, switches, relays, timers, and/or other devices may be included in analog start module 422 to implement various conditions to be met before issuing vehicle activation command 408 to boot module 420. The transition of electric snowmobile 100 from the off state to an active state (such as the neutral state) may be prevented if the applicable conditions are not met.

FIG. 13 is a schematic diagram of another exemplary activation controller 200 that may be incorporated into the control system of electric snowmobile 100. Activation controller 200 may include elements previously described with like elements being identified using like reference numerals. Activation controller 200 may include a boot module 520 operatively connected to a digital start module 522. Boot module 520 may include first MC 410A configured to monitor for the receipt of vehicle activation command 408. In response to vehicle activation command 408, first MC 410A may output the digital power-on signal to cause the transition of electric snowmobile 100 from the off state to an active state. First MC 410A may be powered by LV battery 210 when electric snowmobile 100 is in the inactive state.

Vehicle activation command 408 may include a digital signal transmitted to first MC 410A via a data bus (e.g., CAN bus) for example. Vehicle activation command 408 may be generated by digital start module 522, which may be separate from or part of activation controller 200. Digital start module 522 may function to generate vehicle activation command 408 in digital form when one or more conditions are met. For example, digital start module 522 may include second MC 410B in data communication with first MC 410A of boot module 520. Second MC 410B may be configured to monitor for one or more conditions such as user's authorization to operate electric snowmobile 100 and/or an user input received via a widget of the user interface (e.g., instrument panel 134) of electric snowmobile 100, and generate the vehicle activation command 408 in digital form in response to the conditions being met. For example, second MC 410B may be configured to monitor for the pressing of start button 404 and/or the presence of key 400 in receptacle 402.

Instead of, or in addition to start button 404 and key 400, second MC 410B may monitor for other conditions to implement various conditions to be met before issuing vehicle activation command 408. Such other conditions may include the proximity of key 400 to electric snowmobile 100, the pairing of a user's PED with electric snowmobile 100, and/or the receipt of a wireless signal indicative of a request to start electric snowmobile 100 from an authorized or recognized communication device. In some embodiments, second MC 410B may implement the battery timer to issue vehicle activation command 408 at a predetermined time and/or intermittently to charge a LV battery 210 during extended periods of inactivity (e.g., during an off-season for an electric powersports vehicle).

Second MC 410B may be powered by LV battery 210. In some embodiments, as described above, activation controller 200, including first MC 410A and second MC 410B, may be the only electrical load powered by LV battery 210 when electric snowmobile 100 is in the inactive state.

Systems and methods are described and shown in the present disclosure in relation to the snowmobile 100, but the present disclosure may also be applied to other types of vehicles, including other types of off-road and powersport vehicles.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. An electric vehicle comprising:
a vehicle controller to control operation of the electric vehicle when the electric vehicle is in an on state and enter a powered-off state when the electric vehicle is in an off state; and
an activation controller to store a programmable wake time, the activation controller to switch the vehicle controller to a powered-on state from the powered-off state to wake the electric vehicle from the off state to the on state at the wake time.

2. The electric vehicle of claim 1, wherein the wake time is programmable by the vehicle controller.

3. The electric vehicle of claim 1, wherein the vehicle controller is a main body controller.

4. The electric vehicle of claim 1, wherein the activation controller is the only controller of the electric vehicle which is powered-on when the electric vehicle is in the off state.

5. The electric vehicle of claim 1, wherein the wake time is based on a user designated time.

6. The electric vehicle of claim 5, wherein the user designated time is specified in a user entry of a local task schedule stored by the activation controller or the vehicle controller.

7. The electric vehicle of claim 6, where the user entry of the local task schedule includes the user designated time and has a corresponding designated vehicle operation, upon being turned to the powered-on state from the power-off state by activation controller at the wake time, the vehicle controller to perform the corresponding vehicle operation designated by the user entry.

8. The electric vehicle of claim 7, wherein the designated vehicle operation comprises a battery preconditioning operation of a high-voltage battery of the electric vehicle.

9. The electric vehicle of claim 8, where the vehicle controller performs the battery preconditioning operation only if the electric vehicle is powered from external power equipment.

10. The electric vehicle of claim 7, where the designated vehicle operation comprises a status report of one or more operating parameters of the electric vehicle, including operating parameters of a high-voltage battery of the electric vehicle.

11. The electric vehicle of claim 1, wherein the wake time is based on a wake interval.

12. The electric vehicle of claim 11, when the electric vehicle is in the off state, upon expiration of the wake interval, the activation controller to turn the vehicle controller to the powered-on state from the powered-off state to wake the electric vehicle from the off state to the on state, and to initiate the vehicle controller to perform a check for remote user communication with the electric vehicle which was made when the electric vehicle was in the off state.

13. The electric vehicle of claim 12, to perform the check for remote user communication, the vehicle controller to download remotely entered user designated times from a memory remote to the electric vehicle to the memory of the activation controller.

14. The electric vehicle of claim 11, wherein the wake interval is fixed over time.

15. The electric vehicle of claim 11, wherein the wake interval varies over time based on user interactions with the electric vehicle.

16. The electric vehicle of claim 1, further comprising:
a high-voltage (HV) battery; and
a low-voltage (LV) battery, wherein:
the activation controller is powered from the LV battery; and
the vehicle controller is powered from the HV battery via a direct current to direct current (DC/DC) converter when the electric vehicle is in the on state, and electrically disconnected from the HV battery when the vehicle is in the off state.

17. The electric vehicle of claim 16, wherein the wake time is based on a battery charging interval.

18. The electric vehicle of claim 17, when the electric vehicle is in the off state, upon expiration of a battery charging interval, the activation controller to turn the vehicle controller to a powered-on state from a powered-off state to wake the electric vehicle from an off state to an on state, and to initiate the vehicle controller to perform a charging operation of the LV battery from the HV battery.

19. A method of operating an electric vehicle having an off state and an on-state, the method comprising:
storing a programmable wake time in an activation controller of the electric vehicle;
switching a vehicle controller of the electrical vehicle to a powered-off state to switch the electric vehicle to the off state; and
waking the electric vehicle from the off state to the on state at the wake time by employing the activation controller to turn the vehicle controller from the powered-off state to a powered-on state.

20. An electrical system for an electric vehicle, the electrical system comprising:
an electric motor for propelling the vehicle;
a vehicle controller for controlling operation of the electric vehicle;
a high-voltage (HV) battery to power the electric vehicle, including the electric motor and vehicle controller;
a low-voltage (LV) battery having a lower voltage than the HV battery; and
an activation controller powered from the LV battery, at a wake time stored by the activation controller, the activation controller to provide an activation signal to transition the electric vehicle from an off-state, in which the HV battery is electrically disconnected from the electric motor and the vehicle controller, to an active state, where at least the vehicle controller is electrically connected to and powered from the HV battery.
